(19) United States
(12) Patent Application Publication
(10) Pub. No.: US 2017/0371838 A1
(43) Pub. Date: Dec. 28, 2017

(54) INFORMATION PROCESSING APPARATUS AND IMAGE PROCESSING METHOD

(71) Applicant: FUJITSU LIMITED, Kawasaki-shi (JP)

(72) Inventor: Akihiko Kasagi, Kawasaki (JP)

(73) Assignee: FUJITSU LIMITED, Kawasaki-shi (JP)

(21) Appl. No.: 15/607,973

(22) Filed: May 30, 2017

(30) Foreign Application Priority Data
Jun. 28, 2016 (JP) 2016-127714

(51) Int. Cl. G06F 17/15; G06K 9/54; G06T 1/60

(52) U.S. Cl. CPC G06F 17/153; G06K 9/54; G06T 1/60

(57) ABSTRACT

A processor of an information processing apparatus generates an extended image by adding pixels to outside of a target image. The processor generates an integral image. A value of each element of the integral image is a sum of pixel values of first pixels of the extended image. The first pixels are included in a direction toward an origin of the extended image from a pixel corresponding to the element of the integral image. The processor generates a partial-sum matrix for each pixel of a reduced image using the integral image. A value of each element of the partial-sum matrix is a sum of pixel values of second pixels of the extended image. The second pixels are included in an area corresponding to the element of the partial-sum matrix. The processor performs a convolution operation on the partial-sum matrix using the filter matrix.

### CROSS-REFERENCE TO RELATED APPLICATION

This application is based upon and claims the benefit of priority of the prior Japanese Patent Application No. 2016-127714, filed on Jun. 28, 2016, the entire contents of which are incorporated herein by reference.

### FIELD

The embodiments discussed herein are related to an information processing apparatus and an image processing method.

### BACKGROUND

In an image processing field, a technique has been known which detects feature points such as corners of an object using an image called an image pyramid in which a resolution of an input image is hierarchically lowered. For example, when the entire input image is searched to detect a feature point, as the resolution of the input image is increased, the calculation amount increases in the process of detecting the feature point from the input image. In this case, for example, in the image pyramid, the feature points are sequentially searched for from an image having a low resolution and a search range in the input image is determined. Therefore, the calculation amount is reduced in the process of detecting the feature point from the input image as compared with the case where the entire input image is searched to detect the feature point.

Related techniques are disclosed in, for example, Japanese Laid-Open Patent Publication No. 2010-009599.

### SUMMARY

According to an aspect of the present invention, provided is an information processing apparatus for generating a reduced image from a target image. The information processing apparatus includes a memory and a processor coupled to the memory. The processor is configured to input the target image. The target image is a matrix of pixels. The processor is configured to generate an extended image obtained by adding pixels to outside of the target image depending on a size of a predetermined filter matrix. The processor is configured to generate an integral image from the extended image. A value of each element of the integral image is a sum of pixel values of first pixels of the extended image. The first pixels are included in a direction toward an origin of the extended image from a pixel corresponding to the element of the integral image. The processor is configured to generate a partial-sum matrix for each pixel of the reduced image using the integral image. The partial-sum matrix has the same size as the filter matrix. A value of each element of the partial-sum matrix is a sum of pixel values of second pixels of the extended image. The second pixels are included in an area corresponding to the element of the partial-sum matrix. The processor is configured to perform a convolution operation on the partial-sum matrix using the filter matrix. The processor is configured to calculate a product of a result of the convolution operation and a predetermined reduction rate to obtain a pixel value of each pixel of the reduced image. The processor is configured to output the reduced image.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an information processing apparatus and an image processing method according to a first embodiment;

FIG. 2 is a diagram illustrating an information processing apparatus and an image processing method according to a second embodiment;

FIG. 3 is a diagram illustrating a process of reducing a target image;

FIG. 4 is a diagram illustrating a partial-sum matrix;

FIG. 5 is a diagram illustrating an exemplary method of generating an integral image;

FIG. 6 is a diagram illustrating an exemplary flow of image processing performed by a reduced-image generation unit illustrated in FIG. 2;

FIG. 7 is a diagram illustrating a comparative example of the exemplary flow illustrated in FIG. 6;

FIG. 8 is a diagram illustrating an exemplary operation of an information processing apparatus illustrated in FIG. 2;

FIG. 9 is a diagram illustrating an example of a reduced-image generation process illustrated in FIG. 8;

FIG. 10 is a diagram illustrating an information processing apparatus and an image processing method according to a third embodiment;

FIG. 11 is a diagram illustrating an exemplary operation of an information processing apparatus illustrated in FIG. 10; and

FIG. 12 is a diagram illustrating an exemplary hardware configuration of a computer which executes an image processing program.

### DESCRIPTION OF EMBODIMENTS

An information processing apparatus which generates a reduced image having a resolution lower than the resolution of the input image performs, for example, a filtering process on the input image. The information processing apparatus generates a reduced image by calculating an average of pixel values for a predetermined number of pixels in the image on which the filtering process has been performed. This kind of information processing apparatus performs a convolution operation using a predetermined filter on an extended image obtained by extending the input image when the filtering process is performed. For example, in the filtering process, the convolution operation is performed as much as the number of pixels of the input image. Since multiplication with a larger calculation amount than addition is performed as much as the number of elements of the filter in one convolution operation, there is a tendency in that the calculation amount in the image processing for generating a reduced image is increased when the ratio of the convolution operation is increased among operations performed during the image processing.

Hereinafter, embodiments will be described with reference to accompanying drawings. In the following, the same reference numerals as the reference numerals which denote an image, a matrix, etc. are used for information indicating the image, the matrix, etc. Further, in the following, the same reference numerals as the reference numerals which denote a pixel of an image and an element of a matrix are used for a pixel value of the pixel and a value of the element to describe a flow of the image processing.

### First Embodiment

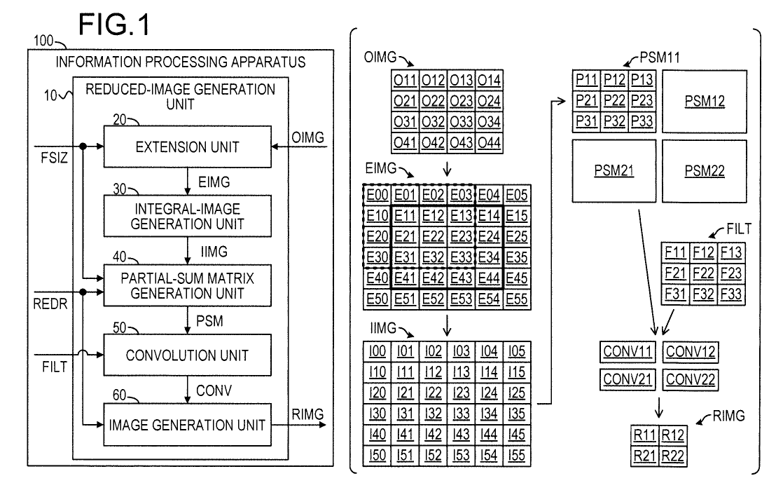

FIG. 1 illustrates an information processing apparatus and an image processing method according to a first embodiment. The processing such as image processing which is performed by the information processing apparatus 100 illustrated in FIG. 1 may be implemented only by hardware or may be implemented by controlling the hardware using software such as an image processing program. For example, the image processing program may be executed by a central processing unit (CPU) installed in the information processing apparatus 100 to perform the image processing.

An exemplary flow of the image processing is illustrated in the right side of FIG. 1. The second digit of a number at an end of a reference numeral of each pixel of images OIMG, EIMG, IIMG, and RIMG corresponds to a row number of the pixel and the first digit of the number corresponds to a column number of the pixel. Similarly, the second digit of a number at an end of a reference numeral of each element of matrices PSM11 and FILT corresponds to a row number of the element and the first digit of the number corresponds to a column number of the element. The image OIMG is a target image which is an image to be reduced, the image EIMG is an extended image obtained by extending the target image OIMG, and the image IIMG is an integral image of the extended image EIMG. In the extended image EIMG and the integral image IIMG, the row number and the column number begin with “0” in order to make the correspondence with the target image OIMG easier to be understood.

For example, the information processing apparatus 100 performs a feature point detection of detecting a feature point such as a corner of an object from the original image, a pattern matching between the original image and a predetermined pattern, or the like using an image called an image pyramid in which a resolution of the original image is hierarchically lowered. For example, a calculation amount in a process of detecting the feature point, etc. by searching the entire original image is increased as the resolution of the original image is increased. Therefore, the information processing apparatus 100 searches for a feature point, etc. sequentially from a low resolution image, among images at individual levels in the image pyramid and determines a search range in the original image. Then, the information processing apparatus 100 detects a feature point, etc. from the determined search range in the original image. Therefore, the calculation amount in the process of detecting a feature point, etc. from the original image is reduced as compared with a case where the entire original image is searched to detect the feature point.

For example, the information processing apparatus 100 includes a reduced-image generation unit 10 which reduces the target image OIMG, which is an image to be reduced, to generate the reduced image RIMG. For example, the information processing apparatus 100 generates an image pyramid by repeating a process of inputting the reduced image RIMG generated in the reduced-image generation unit 10 to the reduced-image generation unit 10 as a target image OIMG.

The reduced-image generation unit 10 includes an extension unit 20, an integral-image generation unit 30, a partial-sum matrix generation unit 40, a convolution unit 50, and an image generation unit 60. The reduced-image generation unit 10 may be implemented only by hardware or may be implemented by executing software such as an image processing program by a CPU mounted in the information processing apparatus 100. In this case, the image processing program which causes the CPU to perform an operation of the reduced-image generation unit 10 is an example of the image processing program which causes the computer to perform the image processing to reduce the target image OIMG, which is an image to be reduced, to generate the reduced image RIMG.

The extension unit 20 receives information indicating the size FSIZ of the filter matrix FILT, which is used in a filtering process of the target image OIMG, as well as information indicating the target image OIMG. The extension unit 20 generates the extended image EIMG obtained by adding a pixel to the outside of the target image OIMG depending on the size of the filter matrix FILT and outputs information indicating the extended image EIMG to the integral-image generation unit 30.

The filter matrix FILT is used in the filtering process within image processing. Examples of the image processing include an edge extraction and a sharpening process. A predetermined matrix is appropriately input to the filter matrix FILT depending on a desired image processing.

For example, when the size FSIZ of the filter matrix FILT is k×k and the number of pixels of the target image OIMG is n×n, the extension unit 20 generates the extended image EIMG by adding pixels to the outside of the target image OIMG so as to make the number of pixels to be (n+k−1)×(n+k−1). Here, n and k are positive integers.

In the example illustrated in the right side of FIG. 1, since the size FSIZ of the filter matrix FILT is “3×3” (k=3), the extension unit 20 extends the target image OIMG of 4×4 pixels to the outside by one pixel (=(k−1)/2) to generate a 6×6 extended image EIMG. The pixel values of pixels E11 to E14, E21 to E24, E31 to E34, and E41 to E44 (pixels E within an area enclosed by a bold line in the drawing) of the extended image EIMG are equal to the pixel values of pixels O11 to O14, O21 to O24, O31 to O34, and O41 to O44 of the target image OIMG, respectively. A pixel value of a pixel E (e.g., a pixel E00) extended from the target image OIMG, that is, a pixel value of a pixel E which is added to the outside of the target image OIMG, is set to “0”, for example. The pixel value of a pixel E (e.g., the pixel E00) extended from the target image OIMG may be a value other than “0”.

The integral-image generation unit 30 generates the integral image IIMG which has a total of pixel values of pixels included in a direction toward the origin (directed to the pixel E00) for each pixel E of the extended image EIMG, as an element I corresponding to each pixel E of the integral image IIMG. For example, an element 105 of the integral image IIMG indicates a total of pixel values of pixels E (pixels E00, E01, E02, E03, E04, and E05 in a 0-th row) within a linear area which includes the pixel E00 and the pixel E05 of the extended image EIMG as the both ends. For example, an element I50 of the integral image IIMG indicates a total of pixel values of pixels E (pixels E00, E10, E20, E30, E40, and E50 in the 0-th column) within a linear area which includes the pixel E00 and the pixel E50 of the extended image EIMG as the both ends. An element 133 of the integral image IIMG indicates a total of pixel values of pixels E (pixels E00 to E03, E10 to E13, E20 to E23, and E30 to E33) within a rectangular area (an area of the extended image EIMG enclosed by a dotted line in FIG. 1) which includes the pixel E00 and the pixel E33 of the extended image EIMG as opposing corners. The integral image IIMG is also referred to as a summed area tablet and obtained by calculating an accumulated sum of individual rows and individual columns of pixel values of the pixels E of the extended image EIMG.

The partial-sum matrix generation unit 40 receives information indicating the integral image IIMG generated by the integral-image generation unit 30, information indicating the size FSIZ of the filter matrix FILT, and information indicating a reduction rate REDR of reducing the target image OIMG. The partial-sum matrix generation unit 40 generates partial sum matrices PSM corresponding to respective pixel R of the reduced image RIMG using the integral image IIMG, etc. The partial sum matrices PSM each have the same size as the filter matrix FILT. The number at the end of the reference numeral of a partial-sum matrix PSM corresponds to the number at the end of the reference numeral of the pixel R of the reduced image RIMG. For example, a partial-sum matrix PSM11 is used to calculate a pixel value of a pixel R11 of the reduced image RIMG. Each element P of the partial-sum matrix PSM indicates a total of pixel values of a plurality of pixels E of the extended image EIMG within a range determined based on the reduction rate REDR of reducing the target image OIMG.

In the example illustrated in FIG. 1, the reduction rate REDR is “¼”. That is, 2×2 pixels O of the target image OIMG are reduced to one pixel R. In this case, for example, an element P11 of the partial-sum matrix PSM11 indicates a total of the pixel values of four pixels E00, E01, E10, and E11 of the extended image EIMG, and an element P12 indicates a total of the pixel values of four pixels E01, E02, E11, and E12 of the extended image EIMG. Further, for example, an element P21 of the partial-sum matrix PSM11 indicates a total of the pixel values of four pixels E10, E11, E20, and E21 of the extended image EIMG, and an element P33 indicates a total of the pixel values of four pixels E22, E23, E32, and E33 of the extended image EIMG.

For example, the element P33 of the partial-sum matrix PSM11 is calculated from the elements I33, I31, I13, and I11 of the integral image IIMG (P33=I33−I31−I13+I11). The partial-sum matrix generation unit 40 outputs information indicating the partial sum matrices PSM to the convolution unit 50.

The convolution unit 50 receives information indicating the filter matrix FILT and information indicating the partial sum matrices PSM, and performs a convolution operation on the partial sum matrices PSM using the filter matrix FILT. The convolution unit 50 outputs results CONV of the convolution operation between the filter matrix FILT and the partial-sum matrix PSM to the image generation unit 60.

For example, a result CONV11 of the convolution operation between the filter matrix FILT and the partial-sum matrix PSM11 is used to calculate a pixel value of the pixel R11 of the reduced image RIMG. A result CONV12 of the convolution operation between the filter matrix FILT and a partial-sum matrix PSM12 is used to calculate a pixel value of a pixel R12 of the reduced image RIMG. A result CONV21 of the convolution operation between the filter matrix FILT and a partial-sum matrix PSM21 is used to calculate a pixel value of a pixel R21 of the reduced image RIMG. A result CONV22 of the convolution operation between the filter matrix FILT and a partial-sum matrix PSM22 is used to calculate a pixel value of a pixel R22 of the reduced image RIMG. As described above, the reduced-image generation unit 10 illustrated in FIG. 1 performs the convolution operation for as many as the number of pixels of the reduced image RIMG.

The image generation unit 60 receives information indicating the results CONV of the convolution operation between the filter matrix FILT and the partial-sum matrix PSM and the reduction rate REDR. The image generation unit 60 calculates a product of the result CONV of the convolution operation on the partial-sum matrix PSM corresponding to each pixel R of the reduced image RIMG and the reduction rate REDR as a pixel value of the pixel R of the reduced image RIMG to generate the reduced image RIMG. For example, the image generation unit 60 calculates the product of the result CONV11 of the convolution operation between the filter matrix FILT and the partial-sum matrix PSM11 and the reduction rate REDR (¼ in the example illustrated in FIG. 1) as a pixel value of the pixel R11 of the reduced image RIMG.

For example, an image processing apparatus of the related art, which calculates an average of pixel values for a predetermined number of pixels of an image obtained after performing the filtering process to generate a reduced image RIMG, performs a convolution operation between a filter matrix FILT and an extended image EIMG to generate the image obtained after performing the filtering process. The number of pixels of the image obtained after performing the filtering process is the same as the number of pixels of the target image OIMG. That is, the convolution operation is performed for as many as the number of pixels of the target image OIMG.

In contrast, the reduced-image generation unit 10 illustrated in FIG. 1 performs the convolution operation between the filter matrix FILT and the partial sum matrices PSM to generate the reduced image RIMG instead of performing the convolution operation between the filter matrix FILT and the extended image EIMG. As a result, as compared with the image processing apparatus of the related art, the reduced-image generation unit 10 may reduce the number of convolution operations and reduce a calculation amount in the image processing for generating the reduced image RIMG. The configurations of the information processing apparatus 100 and the reduced-image generation unit 10 are not limited to the example illustrated in FIG. 1.

As described above, according to the first embodiment illustrated in FIG. 1, the reduced-image generation unit 10 generates, using the integral image IIMG, the partial-sum matrix PSM having the same size as the filter matrix FILT as a matrix used for calculating a pixel value of a pixel R of the reduced image RIMG, for every pixel R of the reduced image RIMG. The reduced-image generation unit 10 performs the convolution operation between the filter matrix FILT and the partial-sum matrix PSM, for every pixel R of the reduced image RIMG and calculates a product of the result CONV of the convolution operation and the reduction rate REDR as the pixel value of the pixel R of the reduced image RIMG. Thus, the reduced image RIMG is generated. Therefore, as compared with the method of generating the reduced image RIMG using the result of the convolution operation between the filter matrix FILT and the extended image EIMG, the number of convolution operations is reduced and the calculation amount in the image processing for generating the reduced image RIMG is reduced as well.

### Second Embodiment

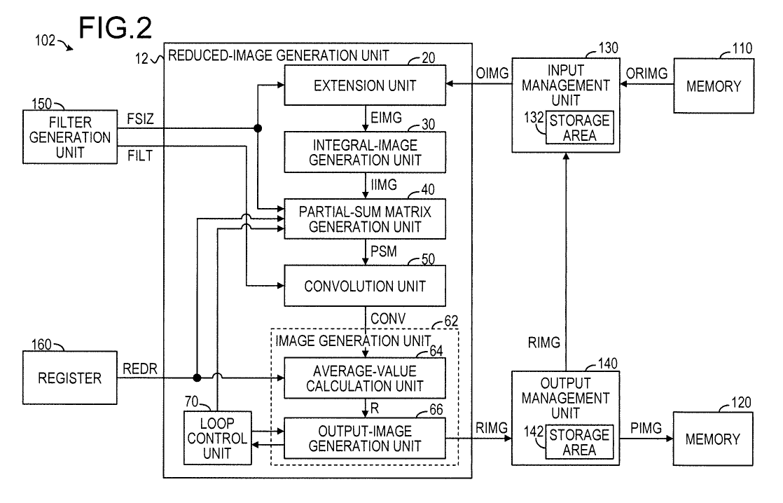

FIG. 2 is a diagram illustrating an information processing apparatus and an image processing method according to a second embodiment. The same or similar elements as the elements described in FIG. 1 are denoted by the same or similar reference numerals and detailed descriptions thereof will be omitted. An information processing apparatus 102 illustrated in FIG. 2 includes a reduced-image generation unit 12, instead of the reduced-image generation unit 10 illustrated in FIG. 1. Further, in the information processing apparatus 102, memories 110 and 120, an input management unit 130, an output management unit 140, a filter generation unit 150, and a register 160 are added to the information processing apparatus 100 illustrated in FIG. 1. Other configurations of the information processing apparatus 102 are the same as or similar to the information processing apparatus 100 illustrated in FIG. 1.

For example, the information processing apparatus 102 performs a feature point detection of detecting feature points such as the corners of an object from an original image ORIMG, a pattern matching between the original image ORIMG and a predetermined pattern, or the like using an image pyramid PIMG in which a resolution of the original image ORIMG is hierarchically lowered. The information processing apparatus 102 generates the image pyramid PIMG by repeating a process of inputting, to the reduced-image generation unit 12, a reduced image RIMG generated by the reduced-image generation unit 12, as a target image OIMG.

For example, the information processing apparatus 102 includes the reduced-image generation unit 12, the memory 110 in which the original image ORIMG is stored in advance, the memory 120 in which the image pyramid PIMG is stored, the input management unit 130, the output management unit 140, the filter generation unit 150, and the register 160. The image pyramid PIMG includes a plurality of reduced images RIMG having different reduction rates REDR of reducing the original image ORIMG.

The reduced-image generation unit 12 repeatedly performs the process of generating the reduced image RIMG of the target image OIMG received from the input management unit 130 to generate the plurality of reduced images RIMG having different reduction rates REDR of reducing the original image ORIMG. Thus, the image pyramid PIMG which includes the plurality of reduced images RIMG having different reduction rates REDR of reducing the original image ORIMG is generated.

The reduced-image generation unit 12 illustrated in FIG. 2 has an image generation unit 62 instead of the image generation unit 60 illustrated in FIG. 1. Further, in the reduced-image generation unit 12, a loop control unit 70 is added to the reduced-image generation unit 10 illustrated in FIG. 1. Other configurations of the reduced-image generation unit 12 are the same as or similar to the reduced-image generation unit 10 illustrated in FIG. 1. For example, the reduced-image generation unit 12 includes an extension unit 20, an integral-image generation unit 30, a partial-sum matrix generation unit 40, a convolution unit 50, an image generation unit 62, and the loop control unit 70.

The extension unit 20 receives information indicating the size FSIZ of a filter matrix FILT from the filter generation unit 150 and receives information indicating a target image OIMG from the input management unit 130. As illustrated in FIG. 1, the extension unit 20 generates an extended image EIMG obtained by adding pixels to the outside of the target image OIMG depending on the size of the filter matrix FILT and outputs information indicating the extended image EIMG to the integral-image generation unit 30. As described for FIG. 1, the integral-image generation unit 30 generates an integral image IIMG of the extended image EIMG and outputs information indicating the generated integral image IIMG to the partial-sum matrix generation unit 40.

The partial-sum matrix generation unit 40 receives information indicating the integral image IIMG from the integral-image generation unit 30, receives information indicating the size FSIZ of the filter matrix FILT from the filter generation unit 150, and receives information indicating a reduction rate REDR of reducing the target image OIMG from the register 160. As described with reference to FIG. 1, the partial-sum matrix generation unit 40 generates, using the integral image IIMG, etc., a partial-sum matrix PSM corresponding to each pixel R of the reduced image RIMG. The partial-sum matrix generation unit 40 illustrated in FIG. 2 repeats the process of generating the partial-sum matrix PSM under the control of the loop control unit 70 until one reduced image RIMG is generated.

The convolution unit 50 receives information indicating the filter matrix FILT from the filter generation unit 150 and receives information indicating the partial-sum matrices PSM from the partial-sum matrix generation unit 40. As described with reference to FIG. 1, the convolution unit 50 performs a convolution operation on the partial-sum matrices PSM using the filter matrix FILT. For example, whenever the convolution unit 50 receives information indicating a partial-sum matrix PSM from the partial-sum matrix generation unit 40, the convolution unit 50 performs the convolution operation between the filter matrix FILT and the received partial-sum matrix PSM. The convolution unit 50 outputs a result CONV of the convolution operation between the filter matrix FILT and the partial-sum matrix PSM to the image generation unit 62.

The image generation unit 62 calculates a product of the result CONV of the convolution operation on the partial-sum matrix PSM corresponding to each pixel R of the reduced image RIMG and the reduction rate REDR as a pixel value of the pixel R of the reduced image RIMG to generate the reduced image RIMG. For example, the image generation unit 62 includes an average-value calculation unit 64 and an output-image generation unit 66.

The average-value calculation unit 64 receives the result CONV of the convolution operation between the filter matrix FILT and the partial-sum matrix PSM from the convolution unit 50 and receives information indicating the reduction rate REDR from the register 160. The average-value calculation unit 64 calculates a product of the result CONV of the convolution operation between the filter matrix FILT and the partial-sum matrix PSM and the reduction rate REDR as an average of values obtained after performing the filtering process on a plurality of pixels corresponding to the reduction rate REDR.

The average of values obtained after performing the filtering process on the plurality of pixels corresponding to the reduction rate REDR corresponds to the pixel value of each pixel R of the reduced image RIMG. That is, the average-value calculation unit 64 calculates a product of the result CONV of the convolution operation on the partial-sum matrix PSM corresponding to each pixel R of the reduced image RIMG and the reduction rate REDR to calculate the pixel value of the pixel R of the reduced image RIMG. The average-value calculation unit 64 outputs the pixel value of each pixel R of the reduced image RIMG to the output-image generation unit 66.

The output-image generation unit 66 receives the pixel value of each pixel R of the reduced image RIMG from the average-value calculation unit 64 and stores the pixel value of each pixel R received from the average-value calculation unit 64. The output-image generation unit 66 outputs the number of stored pixel values of the pixels R to the loop control unit 70. The output-image generation unit 66 outputs the stored pixel values of the pixels R to the output management unit 140 as the reduced image RIMG under the control of the loop control unit 70. For example, when the pixel values of all pixels R of the reduced image RIMG are received from the average-value calculation unit 64, the output-image generation unit 66 outputs the pixel values of all pixels R of the reduced image RIMG to the output management unit 140 as the reduced image RIMG.

The input management unit 130 has a storage area 132 for storing one sheet of image and manages the contents to be input to the extension unit 20 in the reduced-image generation unit 12. For example, the input management unit 130 transmits an image stored in the storage area 132 to the extension unit 20 in the reduced-image generation unit 12 as the target image OIMG. The image stored in the storage area 132 of the input management unit 130 is initialized with the original image ORIMG received from the memory 110 and updated to a reduced image RIMG whenever the reduced image RIMG is received from the output management unit 140. That is, the input management unit 130 receives the original image ORIMG or the reduced image RIMG as a target image OIMG and transmits the target image OIMG to the reduced-image generation unit 12.

The output management unit 140 has a storage area 142 for storing the image pyramid PIMG. For example, the output management unit 140 transmits the reduced image RIMG generated by the reduced-image generation unit 12 to the input management unit 130 and stores the reduced image RIMG in the storage area 142 as an image at each level of the image pyramid PIMG. Thus, the image pyramid PIMG which includes a plurality of reduced images RIMG having different reduction rates REDR of reducing the original image ORIMG, as the images at respective levels, is generated. The output management unit 140 stores the image pyramid PIMG stored in the storage area 142 in the memory 120.

The filter generation unit 150 generates the filter matrix FILT used in the filtering process of the target image OIMG and outputs information indicating the filter matrix FILT and information indicating the size FSIZ of the filter matrix FILT to the reduced-image generation unit 12. For example, the filter generation unit 150 outputs information indicating the size FSIZ of the filter matrix FILT to the extension unit 20 and the partial-sum matrix generation unit 40 in the reduced-image generation unit 12 and outputs information indicating the filter matrix FILT to the convolution unit 50 in the reduced-image generation unit 12.

Information indicating a reduction rate REDR of reducing the target image OIMG is stored in the register 160. For example, the register 160 outputs the information indicating the reduction rate REDR to the partial-sum matrix generation unit 40 and the average-value calculation unit 64 in the reduced-image generation unit 12.

The configurations of the information processing apparatus 102 and the reduced-image generation unit 12 are not limited to the example illustrated in FIG. 2. For example, the filter generation unit 150 may transmit a previously generated filter matrix FILT to the reduced-image generation unit 12. In this case, the filter generation unit 150 may omit the process of generating the filter matrix FILT. For example, the register 160 may be omitted. Different areas in the same memory may be allocated as the memories 110 and 120. An area in the memory 120 may be allocated to the storage area 142. The input management unit 130, the output management unit 140, the filter generation unit 150, the register 160, and the like may be provided in the reduced-image generation unit 12.

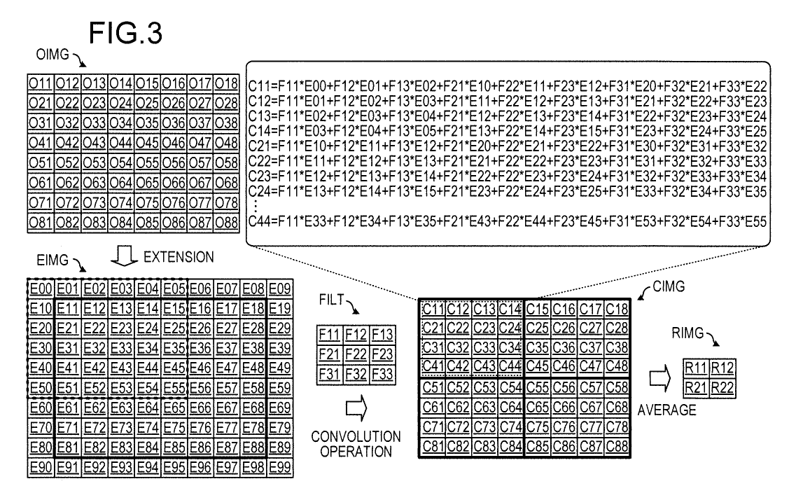

FIG. 3 illustrates a process of reducing a target image OIMG. FIG. 3 illustrates a related-art process of generating a reduced image RIMG by calculating an average of pixel values for a predetermined number of pixels C in the image CIMG obtained after performing the filtering process. In the example illustrated in FIG. 3, a target image OIMG of 8×8 pixels is reduced by ¼ using 3×3 filter matrix FILT in both a row direction and a column direction. That is, the target image OIMG of 8×8 pixels is reduced by 1/16.

An extended image EIMG is generated by adding pixels to the outside of the target image OIMG depending on the size of the filter matrix FILT. Then, a convolution operation between the filter matrix FILT and the extended image EIMG is performed to generate an image CIMG. The image CIMG is an image obtained by performing the filtering process with the filter matrix FILT on the target image OIMG. Further, an average of the pixel values is calculated for every pixel group of 4×4 pixels in the image CIMG obtained after performing the filtering process to generate the reduced image RIMG.

For example, a pixel value of a pixel R11 of the reduced image RIMG is an average of pixel values of pixels C11 to C14, C21 to C24, C31 to C34, and C41 to C44 (pixels C within a rectangular area enclosed by a dotted line in the image CIMG) of the image CIMG. The pixels C11 to C14, C21 to C24, C31 to C34, and C41 to C44 are represented by Equation 1 using pixel values of pixels E (pixels E00 to E05 and the like) within a rectangular area enclosed by a dotted line in the extended image EIMG and a value of each element F of the filter matrix FILT. In Equation 1, “*” indicates multiplication.

$$C 11 = F 11 * E 00 + F 12 * E 01 + F 13 * E 02 + F 21 * E 10 + F 22 * E 11 + F 23 * E 12 + F 31 * E 20 + F 32 * E 21 + F 33 * E 22 \\ C 12 = F 11 * E 01 + F 12 * E 02 + F 13 * E 03 + F 21 * E 11 + F 22 * E 12 + F 23 * E 13 + F 31 * E 21 + F 32 * E 22 + F 33 * E 23 \\ C 13 = F 11 * E 02 + F 12 * E 03 + F 13 * E 04 + F 21 * E 12 + F 22 * E 13 + F 23 * E 14 + F 31 * E 22 + F 32 * E 23 + F 33 * E 24 \\ C 14 = F 11 * E 03 + F 12 * E 04 + F 13 * E 05 + F 21 * E 13 + F 22 * E 14 + F 23 * E 15 + F 31 * E 23 + F 32 * E 24 + F 33 * E 25 \\ C 21 = F 11 * E 10 + F 12 * E 11 + F 13 * E 12 + F 21 * E 20 + F 22 * E 21 + F 23 * E 22 + F 31 * E 30 + F 32 * E 31 + F 33 * E 32 \\ C 22 = F 11 * E 11 + F 12 * E 12 + F 13 * E 13 + F 21 * E 21 + F 22 * E 22 + F 23 * E 23 + F 31 * E 31 + F 32 * E 32 + F 33 * E 33 \\ C 23 = F 11 * E 12 + F 12 * E 13 + F 13 * E 14 + F 21 * E 22 + F 22 * E 23 + F 23 * E 24 + F 31 * E 32 + F 32 * E 33 + F 33 * E 34 \\ C 24 = F 11 * E 13 + F 12 * E 14 + F 13 * E 15 + F 21 * E 23 + F 22 * E 24 + F 23 * E 25 + F 31 * E 33 + F 32 * E 34 + F 33 * E 35 \\ ⋮ \\ C 44 = F 11 * E 33 + F 12 * E 34 + F 13 * E 35 + F 21 * E 43 + F 22 * E 44 + F 23 * E 45 + F 31 * E 53 + F 32 * E 54 + F 33 * E 55 \qquad ( 1 )$$

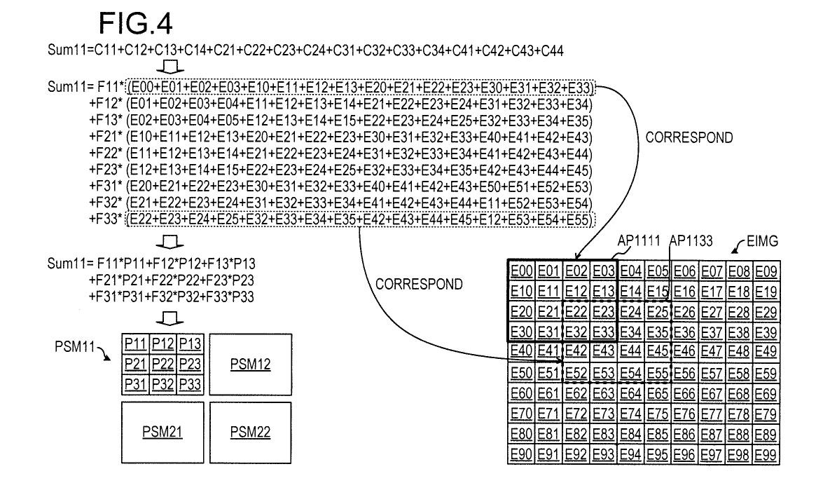

As described above, in the related art process of generating the reduced image RIMG by calculating an average of pixel values for a predetermined number of pixels C in the image CIMG obtained after performing the filtering process, the convolution operation is performed for as many as the number of pixels of the target image OIMG. Instead of generating the image CIMG, the reduced-image generation units 10 and 12 illustrated in FIGS. 1 and 2 perform the convolution operation between the filter matrix FILT and the partial-sum matrix PSM. The partial-sum matrix PSM will be described with reference to FIG. 4.

FIG. 4 illustrates a partial-sum matrix PSM. FIG. 4 illustrates the partial-sum matrix PSM which is generated instead of the image CIMG illustrated in FIG. 3.

A partial sum Sum11 refers to a sum of pixel values of pixels C11 to C14, C21 to C24, C31 to C34, and C41 to C44 of the image CIMG used when the pixel value of the pixel R11 of the reduced image RIMG illustrated in FIG. 3 is calculated.

By bundling elements E of the extended image EIMG for every element F of the filter matrix FILT, the partial sum Sum11 is represented by Equation 2.

$$Sum 11 = F 11 * ( E 00 + E 01 + E 02 + E 03 + E 10 + E 11 + E 12 + E 13 + E 20 + E 21 + E 22 + E 23 + E 30 + E 31 + E 32 + E 33 ) + F 12 * ( E 01 + E 02 + E 03 + E 04 + E 11 + E 12 + E 13 + E 14 + E 21 + E 22 + E 23 + E 24 + E 31 + E 32 + E 32 + E 33 + E 34 ) + F 13 * ( E 02 + E 03 + E 04 + E 05 + E 12 + E 13 + E 14 + E 15 + E 22 + E 23 + E 24 + E 25 + E 32 + E 32 + E 33 + E 34 + E 35 ) + F 21 * ( E 10 + E 11 + E 12 + E 13 + E 20 + E 21 + E 22 + E 23 + E 30 + E 31 + E 32 + E 33 + E 40 + E 41 + E 42 + E 43 ) + F 22 * ( E 11 + E 12 + E 13 + E 14 + E 21 + E 22 + E 23 + E 24 + E 31 + E 32 + E 33 + E 34 + E 41 + E 42 + E 43 + E 44 ) + F 23 * ( E 12 + E 13 + E 14 + E 15 + E 22 + E 23 + E 24 + E 25 + E 32 + E 33 + E 34 + E 35 + E 42 + E 43 + E 44 + E 45 ) + F 31 * ( E 20 + E 21 + E 22 + E 23 + E 30 + E 31 + E 32 + E 33 + E 40 + E 41 + E 42 + E 43 + E 50 + E 51 + E 52 + E 53 ) + F 32 * ( E 21 + E 22 + E 23 + E 24 + E 31 + E 32 + E 33 + E 34 + E 41 + E 42 + E 43 + E 44 + E 11 + E 52 + E 53 + E 54 ) + F 33 * ( E 22 + E 23 + E 24 + E 25 + E 32 + E 33 + E 34 + E 35 + E 42 + E 43 + E 44 + E 45 + E 12 + E 53 + E 54 + E 55 ) \qquad ( 2 )$$

For example, the value to be multiplied by the element F11 of the filter matrix FILT is a sum of pixel values of the pixels E within a rectangular area AP1111 of 4×4 pixels enclosed by a bold line in FIG. 4, among the pixel values of the pixels E of the extended image EIMG. The value to be multiplied by the element F12 of the filter matrix FILT is a sum of pixel values of the pixels E within a rectangular area obtained by moving the rectangular area AP1111 to the right by one pixel. The value to be multiplied by the element F13 of the filter matrix FILT is a sum of pixel values of the pixels E within a rectangular area obtained by moving the rectangular area AP1111 to the right by two pixels.

The value to be multiplied by the element F21 of the filter matrix FILT is a sum of pixel values of the pixels E within a rectangular area obtained by moving the rectangular area AP1111 to the bottom by one pixel. The value to be multiplied by the element F31 of the filter matrix FILT is a sum of pixel values of the pixels E within a rectangular area obtained by moving the rectangular area AP1111 to the bottom by two pixels. Further, the value to be multiplied by the element F33 of the filter matrix FILT is a sum of pixel values of the pixels E within a rectangular area obtained by moving the rectangular area AP1111 to the right by two pixels and to the bottom by two pixels, that is, a sum of pixel values of the pixels E within the rectangular area AP1133 enclosed by a dotted line.

As described above, each element F of the filter matrix FILT is multiplied by the sum of the pixel values within a rectangular area AP (a rectangular area AP of 4×4 pixels in the example illustrated in FIG. 4) determined based on the reduction ratio REDR, among the pixel values of the pixels E of the extended image EIMG. Therefore, by generating a partial-sum matrix PSM having, as elements P, the sum of the pixel values of the pixels within the rectangular area AP determined based on the reduction ratio REDR, among the pixel values of the pixels E of the extended image EIMG, the generation of the image CIMG may be omitted.

For example, the value of the element P11 of the partial-sum matrix PSM11 corresponding to the pixel R11 of the reduced image RIMG is the sum of the pixel values of the pixels E within the rectangular area AP1111 in the extended image EIMG. The value of the element P33 of the partial-sum matrix PSM11 is the sum of the pixel values of the pixels E within the rectangular area AP1133 in the extended image EIMG.

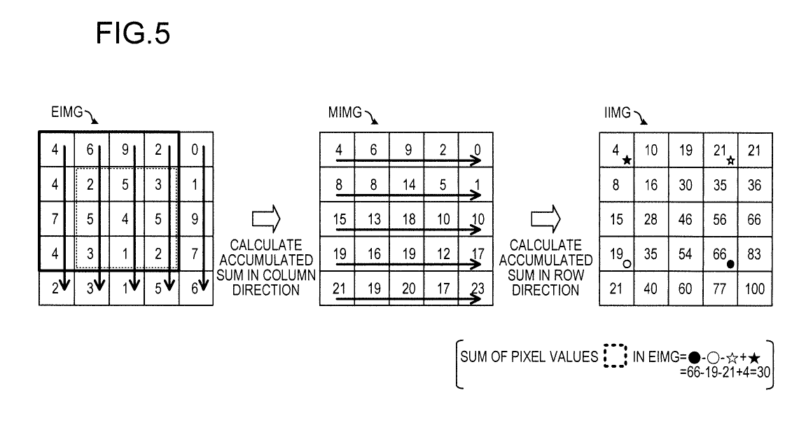

FIG. 5 illustrates an exemplary method of generating an integral image IIMG. That is, FIG. 5 illustrates an exemplary operation of the integral-image generation unit 30 illustrated in FIG. 2. Numbers in the images EIMG, MIMG, and IIMG illustrated in FIG. 5 denote examples of pixel values of respective pixels.

The integral-image generation unit 30 calculates an accumulated sum of pixel values of the pixels E of the extended image EIMG in a column direction. Thus, the image MIMG is generated. Further, the integral-image generation unit 30 calculates an accumulated sum of values of elements in the image MIMG in a row direction. Thus, the integral image IIMG is generated.

Each element I of the integral image IIMG indicates a sum of pixel values of all pixels E of the extended image EIMG included in a direction toward the origin (an upper left side in the example illustrated in FIG. 5) from each pixel E. For example, a value “66” of an element I marked with a black circle among elements I of the integral image IIMG is a sum of pixel values of pixels E within the area enclosed by a bold line in the extended image EIMG illustrated in FIG. 5, among the pixels E of the extended image EIMG.

The sum of the pixel values of the pixels E within an arbitrary rectangular area of the extended image EIMG may be easily calculated using the integral image IIMG. For example, a sum of the pixel values of pixels E within the rectangular area enclosed by a dotted line in the extended image EIMG is calculated using values of four elements I marked with a black circle, a white circle, a white star, and a black star, among the elements I of the integral image IIMG. Four elements I are selected based on a rectangular area for which the sum is to be calculated.

For example, the value “66” of the element I marked with the black circle is a sum of pixel values of all pixels E included in a direction toward the origin from a pixel E at a lower right corner in the rectangular area enclosed by a dotted line in the extended image EIMG. The value “19” of the element I marked with the white circle is a sum of pixel values of all pixels E included in a direction toward the origin from a pixel E at the left side of the pixel E at the lower left corner in the rectangular area enclosed by the dotted line in the extended image EIMG. The value “21” of the element I marked with the white star is a sum of pixel values of all pixels E included in a direction toward the origin from a pixel E at the upper side of the pixel E at the upper right corner in the rectangular area enclosed by the dotted line in the extended image EIMG. Further, the value “4” of the element I marked with the black star is a sum of pixel values of all pixels E included in a direction toward the origin from a pixel E at the upper left side of the pixel E at the upper left corner in the rectangular area enclosed by the dotted line in the extended image EIMG, that is, the pixel value of the pixel E of the origin of the extended image EIMG. Accordingly, the sum of the pixel values of the pixels E within the rectangular area enclosed by the dotted line in the extended image EIMG is calculated by subtracting a summation result of the value of the element I marked with the white circle and the value of the element I marked with the white star from the summation result of the value of the element I marked with the black circle and the value of the element I marked with the black star.

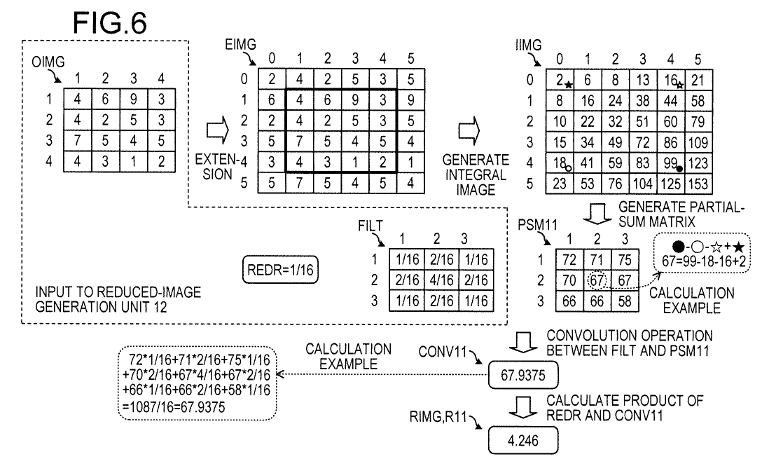

FIG. 6 illustrates an exemplary flow of the image processing performed by the reduced-image generation unit 12 illustrated in FIG. 2. That is, FIG. 6 illustrates an exemplary operation of the reduced-image generation unit 12 illustrated in FIG. 2. Numbers in the images OIMG, EIMG, IIMG, and RIMG illustrated in FIG. 6 denote examples of pixel values of respective pixels, and numbers in the matrices FILT and PSM11 denote an example of values of respective elements. Further, the numbers arranged at the left side and at the upper side of images OIMG, EIMG, and IIMG and the matrices FILT and PSM11 illustrated in FIG. 6 indicate row numbers and column numbers.

In FIG. 6, for example, a target image OIMG of 4×4 pixels is reduced by ¼ in the row direction and the column direction using 3×3 filter matrix FILT. That is, the reduction rate REDR is 1/16.

First, the reduced-image generation unit 12 generates an extended image EIMG obtained by adding pixels to the outside of the target image OIMG depending on the size FSIZ of the filter matrix FILT. For example, the pixel values of pixels O in a second row of the target image OIMG are copied to pixels E of first to fourth columns in the 0-th row of the extended image EIMG. The pixel values of pixels O in a third row of the target image OIMG are copied to pixels E of first to fourth columns in the fifth row of the extended image EIMG. The pixel values of pixels O in a second column of the target image OIMG are copied to pixels E of first to fourth rows in the 0-th column of the extended image EIMG. The pixel values of pixels O in a third column of the target image OIMG are copied to pixels E of first to fourth rows in the fifth column of the extended image EIMG.

The pixel value of a pixel O in a second row and second column of the target image OIMG is copied to a pixel E in the 0-th row and 0-th column of the extended image EIMG. The pixel value of a pixel O in a second row and third column of the target image OIMG is copied to a pixel E in the 0-th row and fifth column of the extended image EIMG. The pixel value of a pixel O in a third row and second column of the target image OIMG is copied to a pixel E in the fifth row and 0-th column of the extended image EIMG. The pixel value of a pixel O in a third row and third column of the target image OIMG is copied to a pixel E in the fifth row and fifth column of the extended image EIMG. The pixel values of the pixels added to the outside of the target image OIMG are not limited to the example illustrated in FIG. 6. For example, the pixel values of the pixels added to the outside of the target image OIMG may be “0”.

Next, as described with reference to FIG. 5, the reduced-image generation unit 12 generates the integral image IIMG of the extended image EIMG. The reduced-image generation unit 12 generates a partial-sum matrix PSM11 corresponding to the pixel R11 of the reduced image RIMG using the integral image IIMG. For example, the value “67” of an element P22 in the second row and second column of the partial-sum matrix PSM11 is calculated using values of four elements I marked with a black circle, a white circle, a white star, and a black star, in the integral image IIMG (67=99−18−16+2). The values of other elements P of the partial-sum matrix PSM11 are also calculated using the values of four elements I selected based on the rectangular areas corresponding to the respective elements P, among the elements I of the integral image IIMG.

Next, the reduced-image generation unit 12 performs a convolution operation on the partial-sum matrix PSM11 using the filter matrix FILT. The convolution operation between the filter matrix FILT and the partial-sum matrix PSM11 is performed, for example, by calculating an accumulated sum of the product of each element F of the filter matrix FILT and an element P of the partial-sum matrix PSM11 at a corresponding position, as illustrated by a calculation example of FIG. 6.

Next, the reduced-image generation unit 12 calculates a product (67.9375* 1/16) of a result CONV11 of the convolution operation between the filter matrix FILT and the partial-sum matrix PSM11 and the reduction rate REDR. Thus, a pixel value “4.246” of the pixel R11 of the reduced image RIMG is calculated. As described above, the convolution operation is performed for as many as the number of pixels of the reduced image RIMG.

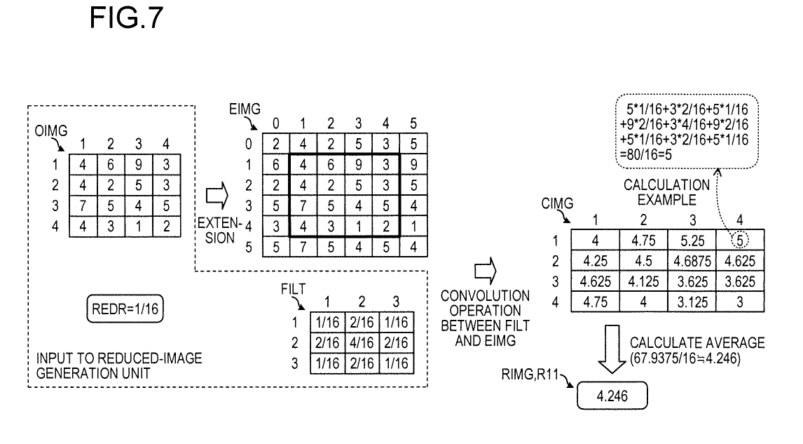

FIG. 7 illustrates a comparative example of the flow of the image processing illustrated in FIG. 6. FIG. 7 illustrates a related-art process of generating a reduced image RIMG by calculating an average of pixel values for a predetermined number of pixels C in the image CIMG obtained after performing the filtering process. The meanings of the numbers, etc. in the images OIMG, EIMG, CIMG, and RIMG illustrated in FIG. 7 are the same as those of FIG. 6. Also in FIG. 7, similarly to FIG. 6, a target image OIMG of 4×4 pixels is reduced by ¼ in the row direction and the column direction using 3×3 filter matrix FILT, as an example. That is, the reduction rate REDR is 1/16.

First, as described with reference to FIG. 6, an extended image EIMG obtained by adding pixels to the outside of the target image OIMG is generated depending on the size FSIZ of the filter matrix FILT.

Next, a convolution operation between the filter matrix FILT and the extended image EIMG is performed to generate an image CIMG. For example, the pixel value “5” of the pixel C in the first row and fourth column of the image CIMG is calculated by calculating an accumulated sum of products of each pixel E within the rectangular area of 3×3 pixels with respect to the pixel E in the first row and fourth column of the extended image EIMG and an element F of the filter matrix FILT at a corresponding position (the calculation example illustrated in FIG. 7).

An average (67.9375/16) of pixel values of every pixel group of 4×4 pixels in the image CIMG obtained after performing the filtering process is calculated to calculate a pixel value (4.246) of the pixel R11 of the reduced image RIMG.

As described above, in the comparative example illustrated in FIG. 7, the convolution operation is performed for as many as the number of pixels of the target image OIMG. In contrast, in the image processing by the reduced-image generation unit 12 illustrated in FIG. 2, as described with reference to FIG. 6, the convolution operation is performed for as many as the number of pixels of the reduced image RIMG. That is, as compared with the comparative example illustrated in FIG. 7, the reduced-image generation unit 12 may reduce the number of convolution operations in generation of the reduced image RIMG and reduce a calculation amount in the image processing for generating the reduced image RIMG. The pixel values of the pixels R of the reduced image RIMG generated by the reduced-image generation unit 12 illustrated in FIG. 6 are equal to the pixel values of the respective pixels R of the reduced image RIMG generated by calculating an average of the pixel values for a predetermined number of pixels C in the image CIMG obtained after performing the filtering process.

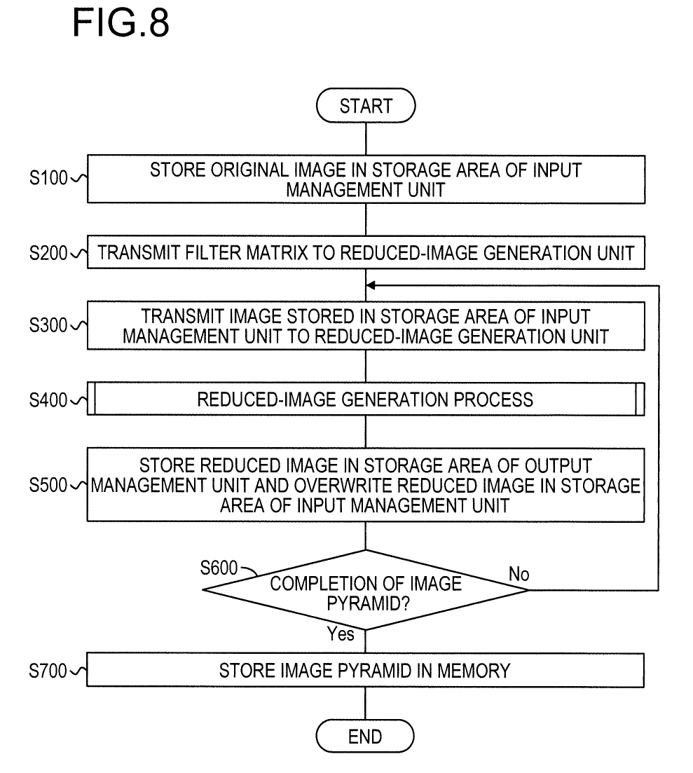

FIG. 8 illustrates an exemplary operation of the information processing apparatus 102 illustrated in FIG. 2. The operation illustrated in FIG. 8 may be implemented only by hardware or may be implemented by controlling hardware using software such as an image processing program. For example, the image processing program may cause the computer to perform the operation illustrated in FIG. 8.

In S100, the input management unit 130 stores, in the storage area 132, an original image ORIMG stored in the memory 110. For example, the input management unit 130 reads the original image ORIMG from the memory 110 and stores the read original image ORIMG in the storage area 132. Thus, the original image ORIMG stored in the memory 110 is stored in the storage area 132 of the input management unit 130 as a target image OIMG.

In S200, the filter generation unit 150 transmits the filter matrix FILT to be used in the filtering process of the target image OIMG to the reduced-image generation unit 12. For example, the filter generation unit 150 outputs information indicating the filter matrix FILT to the convolution unit 50 in the reduced-image generation unit 12 and outputs information indicating the size FSIZ of the filter matrix FILT to the extension unit 20 and the partial-sum matrix generation unit 40 in the reduced-image generation unit 12.

In S300, the input management unit 130 transmits the target image OIMG stored in the storage area 132 to the reduced-image generation unit 12. Therefore, for example, when the reduced-image generation process in S400 is never performed, the original image ORIMG is transmitted from the input management unit 130 to the reduced-image generation unit 12, as the target image OIMG. Further, for example, when the reduced image RIMG generated by the reduced-image generation process in S400 is stored in the storage area 132, the reduced image RIMG is transmitted from the input management unit 130 to the reduced-image generation unit 12 as the target image OIMG.

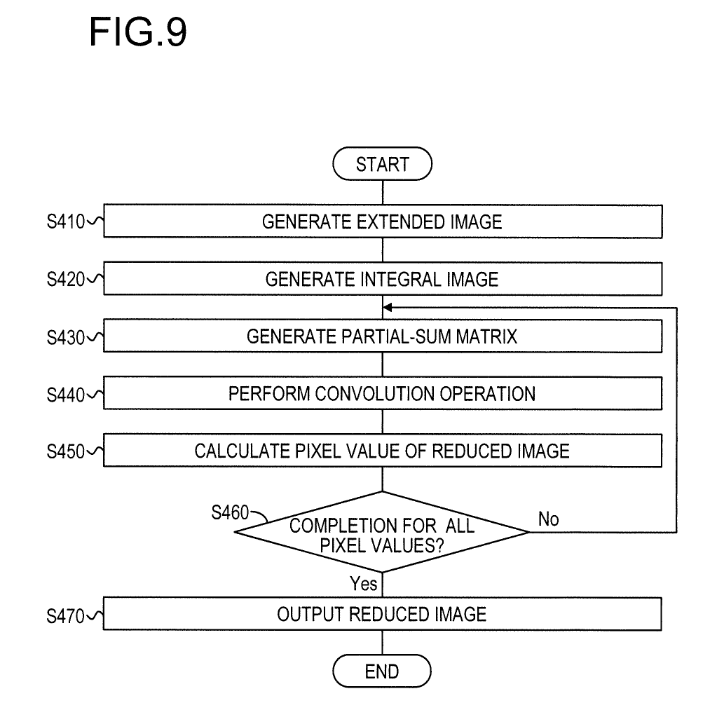

In S400, the reduced-image generation unit 12 performs the reduced-image generation process to generate the reduced image RIMG by reducing the target image OIMG. For example, the reduced-image generation unit 12, as described with reference to FIG. 6, reduces the target image OIMG to generate the reduced image RIMG. Details of the reduced-image generation process will be described with reference to FIG. 9. After performing the reduced-image generation process in S400, the operation of the information processing apparatus 102 proceeds to S500.

In S500, the output management unit 140 stores the reduced image RIMG generated by the reduced-image generation unit 12 in the storage area 142 and overwrites the storage area 132 of the input management unit 130 with the generated reduced image RIMG. Thus, the reduced image RIMG generated by the reduced-image generation unit 12 is stored in the storage area 142 of the output management unit 140 as an image of each level of the image pyramid PIMG and stored in the storage area 132 of the input management unit 130 as the target image OIMG. That is, the target image OIMG used for the next reduced-image generation process is updated to the reduced image RIMG.

In S600, the information processing apparatus 102 determines whether the image pyramid PIMG is completed. For example, the reduced-image generation unit 12 determines whether reduced images RIMG of all levels of the image pyramid PIMG have been generated. When the image pyramid PIMG is completed, the operation of the information processing apparatus 102 proceeds to S700. In contrast, when the image pyramid PIMG is not completed, the operation of the information processing apparatus 102 returns to S300. That is, S300, S400, and S500 are repeated until the image pyramid PIMG is completed.

In S700, the output management unit 140 stores, in the memory 120, the reduced images RIMG stored in the storage area 142 as the image pyramid PIMG. As described above, the information processing apparatus 102 generates the image pyramid PIMG by repeating a process of inputting a reduced image RIMG generated in the reduced-image generation unit 12 to the reduced-image generation unit 12 as a next target image OIMG. The operation of the information processing apparatus 102 is not limited to the example illustrated in FIG. 8.

FIG. 9 illustrates an example of a reduced-image generation process illustrated in FIG. 8. That is, FIG. 9 illustrates an exemplary operation of the reduced-image generation unit 12 illustrated in FIG. 2. The operation illustrated in FIG. 9 is an example of an image processing method of generating the reduced image RIMG by reducing the target image OIMG to be reduced. The operation illustrated in FIG. 9 may be implemented only by hardware or may be implemented by controlling hardware using software such as an image processing program. For example, the image processing program may cause the computer to perform the operation illustrated in FIG. 9.

In S410, the extension unit 20 generates an extended image EIMG by extending the target image OIMG. For example, the extension unit 20 generates the extended image EIMG by adding pixels to the outside of the target image OIMG depending on the size of the filter matrix FILT. The target image OIMG is transmitted, for example, from the input management unit 130 to the reduced-image generation unit 12 in S300 illustrated in FIG. 8 whenever the reduced-image generation process is performed.

Next, in S420, as described with reference to FIG. 5, the integral-image generation unit 30 generates an integral image IIMG of the extended image EIMG.

Next, in S430, as described with reference to FIG. 4, the partial-sum matrix generation unit 40 generates a partial-sum matrix PSM corresponding to each pixel R of the reduced image RIMG using the integral image IIMG, etc. For example, the partial-sum matrix generation unit 40 selects a pixel R whose pixel value is not calculated, among pixels R of the reduced image RIMG and generates a partial-sum matrix PSM corresponding to the selected pixel R using the integral image IIMG, etc.

Next, in S440, the convolution unit 50 performs the convolution operation between the filter matrix FILT transmitted in S200 of FIG. 8 and the partial-sum matrix PSM generated in S430.

Next, in S450, the average-value calculation unit 64 calculates, as the pixel value (the pixel value of the pixel R selected in S440) of the reduced image RIMG, the product of the result CONV of the convolution operation performed in S440 and the reduction rate REDR. That is, the average-value calculation unit 64 calculates, as the respective pixel values of the pixels R of the reduced image RIMG, the product of the result CONV of the convolution operation between the filter matrix FILT and the partial-sum matrix PSM and the reduction rate REDR.

Next, in S460, the loop control unit 70 determines whether all pixel values of the pixels R of the reduced image RIMG have been calculated. For example, when the number of pixel values of the pixels R stored in the output-image generation unit 66 matches the number of pixels of the reduced image RIMG, the loop control unit 70 determines that all pixel values of the pixels R of the reduced image RIMG have been calculated. When all pixel values of the pixels R of the reduced image RIMG are calculated, the operation of the reduced-image generation unit 12 proceeds to S470. When a pixel value of any one pixel R of the reduced image RIMG has not been calculated, the operation of the reduced-image generation unit 12 returns to S430. That is, S430, S440, and S450 are repeated until, for example, a reduced image RIMG corresponding to one level of the image pyramid PIMG is generated.

In S470, the output-image generation unit 66 outputs the pixel values of all pixels R of the reduced image RIMG to the output management unit 140 as the reduced image RIMG. Thus, the reduced image RIMG corresponding to one level of the image pyramid PIMG is transmitted to the output management unit 140. The reduced-image generation process, that is, the operation of the reduced-image generation unit 12 is not limited to the example illustrated in FIG. 9.

As described above, also in the second embodiment described with reference to FIGS. 2 to 9, the same effect as the first embodiment described with reference to in FIG. 1 may be achieved. For example, the reduced-image generation unit 12 generates the partial-sum matrix PSM having the same size as the filter matrix FILT for every pixel R of the reduced image RIMG, using the integral image IIMG, etc. The reduced-image generation unit 12 calculates the product of the result CONV of the convolution operation between the filter matrix FILT and the partial-sum matrix PSM and the reduction rate REDR as the pixel value of each pixel R of the reduced image RIMG to generate the reduced image RIMG. Therefore, as compared with the method of generating the reduced image RIMG using the result of the convolution operation between the filter matrix FILT and the extended image EIMG, the number of convolution operations is reduced and the calculation amount in the image processing for generating the reduced image RIMG is reduced.

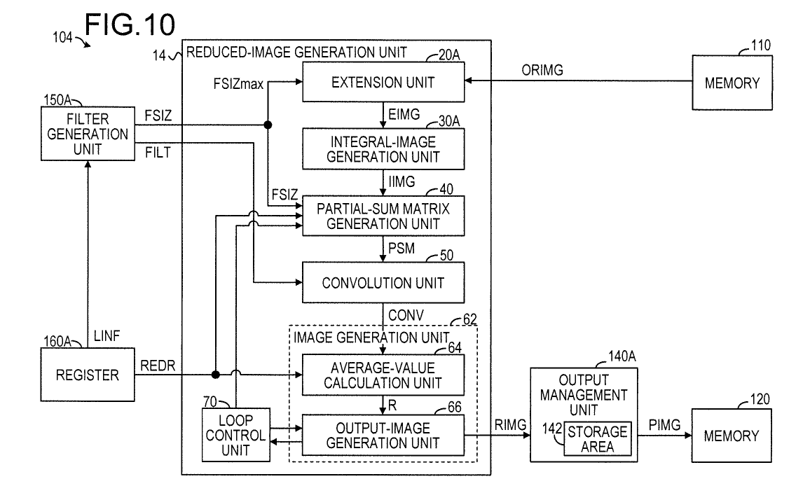

FIG. 10 illustrates an information processing apparatus and an image processing method according to a third embodiment. The same or similar elements as the elements described in FIGS. 1 to 9 are denoted by the same or similar reference numerals and detailed descriptions thereof will be omitted. In the information processing apparatus 104 illustrated in FIG. 10, the input management unit 130 is omitted from the information processing apparatus 102 illustrated in FIG. 2. The information processing apparatus 104 includes a reduced-image generation unit 14, an output management unit 140A, a filter generation unit 150A, and a register 160A, instead of the reduced-image generation unit 12, the output management unit 140, the filter generation unit 150, and the register 160 illustrated in FIG. 2, respectively. Other configurations of the information processing apparatus 104 are the same as or similar to the information processing apparatus 102 illustrated in FIG. 2.

For example, the information processing apparatus 104 performs a feature point detection of detecting feature points such as the corners of an object from an original image ORIMG, a pattern matching between the original image ORIMG and a predetermined pattern, or the like using an image pyramid PIMG in which a resolution of the original image ORIMG is hierarchically lowered. For example, the information processing apparatus 104 includes the reduced-image generation unit 14, a memory 110 in which the original image ORIMG is stored in advance, a memory 120 in which the image pyramid PIMG is stored, the output management unit 140A, the filter generation unit 150A, and the register 160A.

The reduced-image generation unit 14 receives the original image ORIMG stored in the memory 110 as a target image OIMG and generates a plurality of reduced images RIMG having different reduction rates REDR for the target image OIMG (that is, an original image ORIMG). The reduced-image generation unit 14 is the same as or similar to the reduced-image generation unit 12 illustrated in FIG. 2, except that the reduced-image generation unit 14 generates the plurality of reduced images RIMG having different reduction rates REDR for the target image OIMG.

For example, the reduced-image generation unit 14 is the same as or similar to the reduced-image generation unit 12, except that the reduced-image generation unit 14 has an extension unit 20A and an integral-image generation unit 30A, instead of the extension unit 20 and the integral-image generation unit 30 illustrated in FIG. 2, respectively. That is, the reduced-image generation unit 14 includes the extension unit 20A, the integral-image generation unit 30A, a partial-sum matrix generation unit 40, a convolution unit 50, an image generation unit 62, and the loop control unit 70. Prior to the extension unit 20A and the like in the reduced-image generation unit 14, the filter generation unit 150A will be described first.

The filter generation unit 150A receives information indicating the number LINF of levels of the image pyramid PIMG from the register 160A in which the information indicating the number LINF of levels, information indicating the reduction rate REDR, and the like are stored, and generates the filter matrix FILT for every level of the image pyramid PIMG. That is, when the reduced-image generation unit 14 generates the plurality of reduced images RIMG having different reduction rates REDR for the target image OIMG, the filter generation unit 150A generates a plurality of filter matrices FILT corresponding to the plurality of reduced images RIMG, respectively. The filter generation unit 150A transmits the generated filter matrices FILT to the reduced-image generation unit 14.

For example, the filter generation unit 150A outputs information indicating the size FSIZ of the filter matrix FILT to the extension unit 20A and the partial-sum matrix generation unit 40 in the reduced-image generation unit 14 and outputs information indicating the filter matrix FILT to the convolution unit 50 in the reduced-image generation unit 14. Information indicating the maximum size FSIZmax among sizes FSIZ of the plurality of filter matrices FILT is transmitted to the extension unit 20A in the reduced-image generation unit 14. For example, in the image pyramid PIMG called a Gaussian pyramid, a size FSIZ of the filter matrix FILT used to generate the reduced image RIMG having the lowest resolution, that is, the highest reduction rate REDR becomes the maximum size FSIZmax. Other operations of the filter generation unit 150A are the same as or similar to the operation of the filter generation unit 150 illustrated in FIG. 2. Next, the extension unit 20A and the like in the reduced-image generation unit 14 will be described.

The extension unit 20A receives the original image ORIMG stored in the memory 110 as the target image OIMG and receives information indicating the maximum size FSIZmax among the sizes FSIZ of the plurality of filter matrices FILT from the filter generation unit 150A. The extension unit 20A generates an extended image EIMG obtained by adding pixels to the outside of the target image OIMG depending on the maximum size FSIZmax among the sizes FSIZ of the plurality of filter matrices FILT and outputs information indicating the extended image EIMG to the integral-image generation unit 30A.

Since, in the reduced-image generation unit 14, a plurality of reduced images RIMG included in the image pyramid PIMG are generated from one target image OIMG (that is, original image ORIMG), the extension unit 20A generates one extended image EIMG for one image pyramid PIMG. Therefore, the reduced-image generation unit 14 may omit the process of generating the extended image EIMG, that is, the process performed by the extension unit 20A, in the second or later process of generating the reduced image RIMG, among a plurality of processes of generating the reduced image RIMG. Other operations of the extension unit 20A are the same as or similar to the operation of the extension unit 20 illustrated in FIG. 2.

As illustrated in FIG. 5, the integral-image generation unit 30A generates an integral image IIMG of the extended image EIMG and outputs information indicating the generated integral image IIMG to the partial-sum matrix generation unit 40. Since one extended image EIMG is generated for one image pyramid PIMG in the reduced-image generation unit 14, the integral-image generation unit 30A generates one integral image IIMG for one image pyramid PIMG. Therefore, in order to generate a plurality of reduced images RIMG included in the image pyramid PIMG, a common integral image IIMG is used. Therefore, the reduced-image generation unit 14 may omit the process of generating the integral image IIMG, that is, the process performed by the integral-image generation unit 30A, in the second or later process of generating the reduced image RIMG, among a plurality of processes of generating the reduced image RIMG. Other configurations of the integral-image generation unit 30A are the same as or similar to the integral-image generation unit 30 illustrated in FIG. 2.

The partial-sum matrix generation unit 40 is the same as or similar to the partial-sum matrix generation unit 40 illustrated in FIG. 2. For example, the partial-sum matrix generation unit 40 receives information indicating the integral image IIMG, information indicating the size FSIZ of the filter matrix FILT, and information indicating a reduction rate REDR, from the integral-image generation unit 30A, the filter generation unit 150A, and the register 160A, respectively.

In the reduced-image generation unit 14, the partial-sum matrix generation unit 40 receives information indicating the size FSIZ of the filter matrix FILT and information indicating a reduction rate REDR for every reduced image RIMG. Alternatively, instead of receiving the information indicating the reduction rate REDR for every reduced image RIMG, the partial-sum matrix generation unit 40 may receive information indicating a reduction rate REDR of a predetermined level of the image pyramid PIMG from the register 160A. In this case, for example, the partial-sum matrix generation unit 40 calculates the reduction rate REDR of each level of the image pyramid PIMG on the basis of the reduction rate REDR of the predetermined level.

As described with reference to FIG. 4, the partial-sum matrix generation unit 40 generates a partial-sum matrix PSM corresponding to each pixel R of the reduced image RIMG using the integral image IIMG, etc. In the reduced-image generation unit 14, the partial-sum matrix generation unit 40 generates the partial-sum matrices PSM respectively used to generate a plurality of reduced images RIMG, by using the integral image IIMG which is commonly used to generate the plurality of reduced images RIMG.

The convolution unit 50 is the same as or similar to the convolution unit 50 illustrated in FIG. 2. For example, the convolution unit 50 receives information indicating the filter matrix FILT from the filter generation unit 150A and receives information indicating the partial-sum matrix PSM from the partial-sum matrix generation unit 40. In the reduced-image generation unit 14, the convolution unit 50, for example, receives the information indicating the filter matrix FILT for every reduced image RIMG and receives the information indicating the partial-sum matrix PSM for every pixel R of the reduced image RIMG. The convolution unit 50 performs the convolution operation on the partial-sum matrix PSM using the filter matrix FILT and outputs the result CONV of the convolution operation between the filter matrix FILT and the partial-sum matrix PSM to the image generation unit 62.

The image generation unit 62 is the same as or similar to the image generation unit 62 illustrated in FIG. 2. For example, the image generation unit 62 includes an average-value calculation unit 64 and an output-image generation unit 66. The average-value calculation unit 64 and the output-image generation unit 66 are same as or similar to the average-value calculation unit 64 and the output-image generation unit 66 illustrated in FIG. 2, respectively.

For example, the average-value calculation unit 64 receives the result CONV of the convolution operation between the filter matrix FILT and the partial-sum matrix PSM from the convolution unit 50 and receives information indicating the reduction rate REDR from the register 160A. Further, in the reduced-image generation unit 14, the average-value calculation unit 64, for example, receives the result CONV of the convolution operation for every pixel R of each reduced image RIMG and receives the information indicating the reduction rate REDR for every reduced image RIMG. Alternatively, instead of receiving the information indicating the reduction rate REDR for every reduced image RIMG, the average-value calculation unit 64 may receive information indicating a reduction rate REDR of a predetermined level of the image pyramid PIMG from the register 160A. In this case, for example, the average-value calculation unit 64 calculates the reduction rate REDR of each level of the image pyramid PIMG on the basis of the reduction rate REDR of the predetermined level.

The average-value calculation unit 64 calculates the product of the result CONV of the convolution operation between the filter matrix FILT and the partial-sum matrix PSM and the reduction rate REDR as the pixel value of each pixel R of the reduced image RIMG.

The output-image generation unit 66 receives the pixel value of the pixel R of the reduced image RIMG from the average-value calculation unit 64 and stores the pixel value of the pixel R received from the average-value calculation unit 64. The output-image generation unit 66 outputs the stored pixel values of the pixels R to the output management unit 140A as the reduced image RIMG by the control of the loop control unit 70. For example, when the pixel values of all pixels R of the reduced image RIMG are received from the average-value calculation unit 64, the output-image generation unit 66 outputs the pixel values of all pixels R of the reduced image RIMG to the output management unit 140A as the reduced image RIMG.

The loop control unit 70 is the same as or similar to the loop control unit 70 illustrated in FIG. 2. For example, the loop control unit 70 causes the partial-sum matrix generation unit 40 to repeatedly perform the process of generating the partial-sum matrix PSM until the number of pixel values of the pixels R stored in the output-image generation unit 66 matches the number of pixels of the reduced image RIMG. Thus, the partial-sum matrix generation unit 40 repeats the process of generating the partial-sum matrix PSM until one reduced image RIMG is generated.

As described above, the reduced-image generation unit 14 uses the original image ORIMG received from the memory 110 as a target image OIMG to generate a plurality of reduced images RIMG having different reduction rates REDR for the target image OIMG. Thus, the image pyramid PIMG which includes the plurality of reduced images RIMG having different reduction rates REDR of reducing the original image ORIMG is generated.

The output management unit 140A has a storage area 142 in which the image pyramid PIMG is stored and stores the reduced image RIMG generated by the reduced-image generation unit 14 in the storage area 142 as an image of each level of the image pyramid PIMG. The output management unit 140A stores, in the memory 120, the image pyramid PIMG stored in the storage area 142.

In the register 160A, information indicating the number LINF of levels of the image pyramid PIMG and information indicating the reduction rate REDR of reducing the target image OIMG are stored. For example, the register 160A outputs the information indicating the number LINF of levels of the image pyramid PIMG to the filter generation unit 150A and outputs information indicating the reduction rate REDR to the partial-sum matrix generation unit 40 and the average-value calculation unit 64 in the reduced-image generation unit 14.

The configurations of the information processing apparatus 104 and the reduced-image generation unit 14 are not limited to the example illustrated in FIG. 10. For example, the filter generation unit 150A may transmit a previously generated filter matrix FILT to the reduced-image generation unit 14. In this case, the filter generation unit 150A may omit the process of generating the filter matrix FILT. For example, the register 160A may be omitted. Different areas in the same memory may be allocated as the memories 110 and 120. An area in the memory 120 may be allocated to the storage area 142. The output management unit 140A, the filter generation unit 150A, the register 160A, and the like may be provided in the reduced-image generation unit 14.

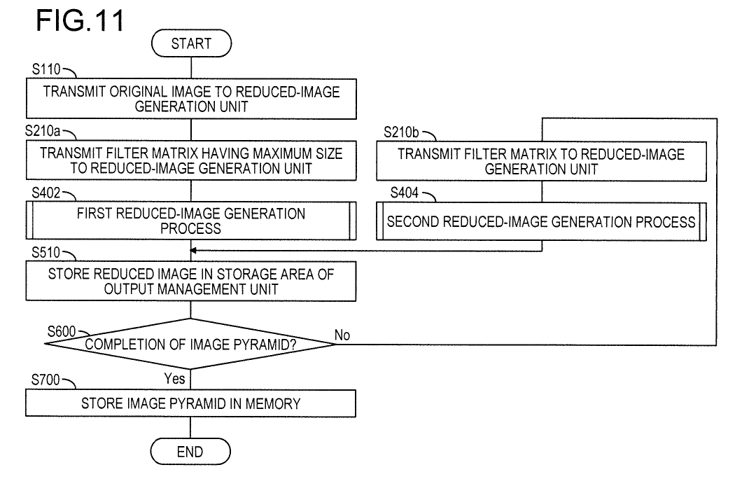

FIG. 11 illustrates an exemplary operation of the information processing apparatus 104 illustrated in FIG. 10. The operation illustrated in FIG. 11 may be implemented only by hardware or may be implemented by controlling hardware using software such as an image processing program. For example, the image processing program may cause the computer to perform the operation illustrated in FIG. 11. In the operation illustrated in FIG. 11, S300 is omitted from the operation illustrated in FIG. 8 and a plurality of reduced images RIMG are generated from one target image OIMG (that is, original image ORIMG). S210a and S210b correspond to S200 illustrated in FIGS. 8, and S510 corresponds to S500 illustrated in FIG. 8. The same or similar processing as the processing described in FIG. 8 are denoted by the same or similar reference numerals and a detailed description thereof will be omitted.

In S110, the information processing apparatus 104 transmits the original image ORIMG stored in the memory 110 to the reduced-image generation unit 14 as a target image OIMG.

Next, in S210a, the filter generation unit 150A transmits a filter matrix FILT having the maximum size FSIZmax among the plurality of filter matrices FILT used in the filtering process of the target image OIMG to the reduced-image generation unit 14. For example, the filter generation unit 150A outputs information indicating the filter matrix FILT having the maximum size FSIZmax to the convolution unit 50 in the reduced-image generation unit 14. Further, the filter generation unit 150A outputs the information indicating the maximum size FSIZmax to the extension unit 20A and the partial-sum matrix generation unit 40 in the reduced-image generation unit 14. After S210a is performed, the operation of the information processing apparatus 104 proceeds to S402.

In S402, the reduced-image generation unit 14 performs a first reduced-image generation process to generate a reduced image RIMG by reducing the target image OIMG. The first reduced-image generation process is the same as or similar to the reduced-image generation process described with reference to FIG. 9. The reduced image RIMG of the target image OIMG corresponding to the image obtained by performing the filtering process using the filter matrix FILT having the maximum size FSIZmax is generated by the first reduced-image generation process. After the first reduced-image generation process is performed in S402, the operation of the information processing apparatus 104 proceeds to S510.

In S510, the output management unit 140A stores the reduced image RIMG generated by the reduced-image generation unit 14 in the storage area 142. Thus, the reduced image RIMG generated by the reduced-image generation unit 14 is stored in the storage area 142 of the output management unit 140 as an image of each level of the image pyramid PIMG.

Next, in S600, the information processing apparatus 104 determines whether the image pyramid PIMG is completed. For example, the reduced-image generation unit 14 determines whether reduced images RIMG of all levels of the image pyramid PIMG have been generated. When the image pyramid PIMG is completed, the operation of the information processing apparatus 104 proceeds to S700. When the image pyramid PIMG is not completed, the operation of the information processing apparatus 104 proceeds to S210b.

In S210b, the filter generation unit 150A transmits a filter matrix FILT which is used for a reduced image RIMG to be generated, among the plurality of filter matrices FILT used in the filtering process of the target image OIMG to the reduced-image generation unit 14. For example, the filter generation unit 150A outputs information indicating the filter matrix FILT to the convolution unit 50 in the reduced-image generation unit 14 and outputs information indicating the size FSIZ of the filter matrix FILT to the extension unit 20A and the partial-sum matrix generation unit 40 in the reduced-image generation unit 14. After S210b is performed, the operation of the information processing apparatus 104 proceeds to S404.

In S404, the reduced-image generation unit 14 performs a second reduced-image generation process to generate the reduced image RIMG by reducing the target image OIMG. In the second reduced-image generation process, the integral image IIMG generated by the first reduced-image generation process in S402 is used. For example, the second reduced-image generation process is the same as or similar to the reduced-image generation process described with reference to FIG. 9 from which S410 and S420 are omitted. The reduced image RIMG of the target image OIMG is generated by the second reduced-image generation process. After the second reduced-image generation process is performed in S404, the operation of the information processing apparatus 104 proceeds to S510. That is, S210b, S404, and S510 are repeated until the image pyramid PIMG is completed.

In S700, the output management unit 140 stores the reduced images RIMG stored in the storage area 142 in the memory 120 as the image pyramid PIMG. As described above, the reduced-image generation unit 14 uses the original image ORIMG stored in the memory 110 as a target image OIMG to generate a plurality of reduced images RIMG having different reduction rates REDR for the target image OIMG. Thus, the image pyramid PIMG which includes the plurality of reduced images RIMG having different reduction rates REDR of reducing the original image ORIMG is generated.

The operation of the information processing apparatus 104 is not limited to the example illustrated in FIG. 11. For example, the information processing apparatus 104 may initially generate a reduced image RIMG other than the reduced image RIMG using the filter matrix FILT having the maximum size FSIZmax among the plurality of filter matrices FILT. In this case, for example, in S210a, the filter generation unit 150A transmits the filter matrix FILT which is used for the reduced image RIMG to be generated, among the plurality of filter matrices FILT used in the filtering process of the target image OIMG to the reduced-image generation unit 14. Further, the filter generation unit 150A outputs information indicating the maximum size FSIZmax among the sizes FSIZ of the plurality of filter matrices FILT to the extension unit 20A in the reduced-image generation unit 14. In the first reduced-image generation process in S402, the extension unit 20A generates an extended image EIMG on the basis of the maximum size FSIZmax of the filter matrix FILT.

As described above, also in the third embodiment described with reference to FIGS. 10 and 11, the same effect as the second embodiment described with reference to FIGS. 2 to 9 may be achieved. For example, the reduced-image generation unit 14 generates the partial-sum matrix PSM having the same size as the filter matrix FILT for every pixel R of the reduced image RIMG, using the integral image IIMG. The reduced-image generation unit 14 calculates the product of the result CONV of the convolution operation between the filter matrix FILT and the partial-sum matrix PSM and the reduction rate REDR as the pixel value of each pixel R of the reduced image RIMG to generate the reduced image RIMG. Therefore, as compared with the method of generating the reduced image RIMG using the result of the convolution operation between the filter matrix FILT and the extended image EIMG, the number of convolution operations is reduced and the calculation amount in the image processing of generating the reduced image RIMG is reduced.

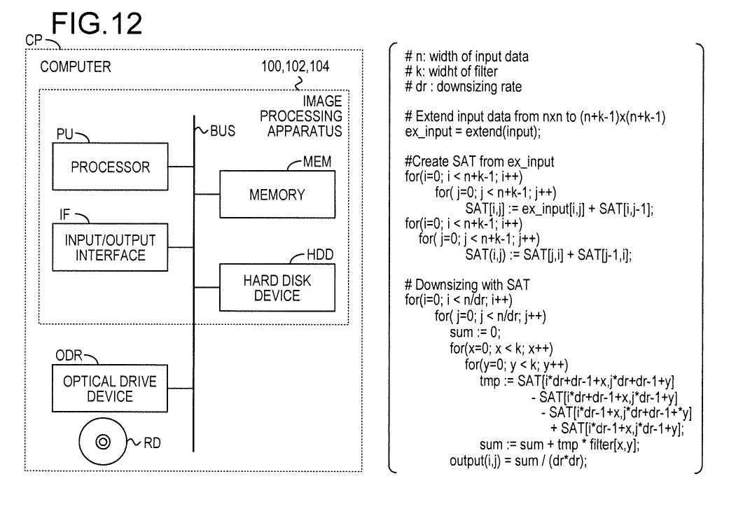

FIG. 12 illustrates an exemplary hardware configuration of a computer which executes an image processing program. The elements the same as or similar to the elements described in FIGS. 1 to 11 are denoted by the same reference numerals and detailed descriptions thereof will be omitted. For example, the image processing program causes a computer CP to perform functions of the information processing apparatus 100, 102, or 104 illustrated in FIG. 1, 2, or 10, respectively. That is, the image processing program causes the computer CP to perform functions of the reduced-image generation unit 10, 12, or 14 illustrated in FIG. 1, 2, or 10. In the right of FIG. 12, an example of a pseudo code of the image processing program which causes the computer to perform the image processing of generating a reduced image RIMG by reducing a target image OIMG is illustrated.

The computer CP includes, for example, a processor PU, a memory MEM, a hard disk device HDD, an input/output interface IF, and an optical drive device ODR. The processor PU, the memory MEM, the hard disk device HDD, the input/output interface IF, and the optical drive device ODR are connected to a bus BUS. The function of each of the information processing apparatuses 100, 102, and 104 are implemented, for example, by the processor PU, the memory MEM, the hard disk device HDD, and the input/output interface IF.

A removable disk RD such as an optical disk may be mounted in the optical drive device ODR and the optical drive device ODR may read and write information recorded in the mounted removable disk RD. The computer CP communicates with the outside of the computer CP via the input/output interface IF. For example, the input/output interface IF may receive an original image ORIMG and transmit the original image ORIMG to the processor PU and the like.

The memory MEM stores therein, for example, an operating system of the computer CR Further, the memory MEM stores therein an application program such as an image processing program which causes the processor PU to perform the operation of the information processing apparatus 100, 102, or 104. The application program such as the image processing program may be stored in the hard disk device HDD.

A portion of an area of the memory MEM may be allocated to the memories 110 and 120 illustrated in FIG. 2. Alternatively, the memories 110 and 120 illustrated in FIG. 2 and the like may be allocated to a storage device (not illustrated) separated from the memory MEM.

The application program such as the image processing program may be recorded in the removable disk RD such as an optical disk and distributed. For example, the computer CP may read the application program such as the image processing program from the removable disk RD via the optical drive device ODR and store the application program in the memory MEM or the hard disk device HDD. Further, the computer CP may download the application program such as the image processing program via a communication device (not illustrated) which accesses a network such as the Internet and store the application program in the memory MEM or the hard disk device HDD.

The image processing program illustrated in the right of FIG. 12 reduces the target image OIMG of n×n pixels by 1/dr in the row direction and the column direction using a k×k filter matrix FILT. That is, the reduction rate REDR is 1/(dr*dr). The summed area tablet (SAT) indicated in the pseudo code corresponds to the integral image IIMG.

In the image processing program illustrated in FIG. 12, during the process of generating SAT (i.e., the integral image IIMG), addition is performed 2*(n+k−1)² times. Further, during the reduction process using the SAT, addition is performed 5*k²*(n/dr)² times and multiplication is performed k²*(n/dr)² times. In the comparative example illustrated in FIG. 7, since the convolution operation is performed for as many as the number (n²) of pixels of the target image OIMG, multiplication may be performed at least k²*n² times. Accordingly, in the image processing program illustrated in FIG. 12, the calculation amount may be reduced as compared with the comparative example illustrated in FIG. 7.

The hardware configuration of the computer which executes the image processing program is not limited to the example illustrated in FIG. 12. For example, in the computer CP, the optical drive device ODR may be omitted. For example, the computer CP may read the application program such as the image processing program from a storage medium other than the optical disk and store the application program in the memory MEM or the hard disk device HDD. In this case, the computer CP may have an interface corresponding to the storage medium in which the application program such as the image processing program is stored. That is, the application program such as the image processing program may well be stored in, for example, the storage medium other than the optical disk.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus for generating a reduced image from a target image, the information processing apparatus comprising:
a memory; and
a processor coupled to the memory and the processor configured to:
input the target image, the target image being a matrix of pixels;
generate an extended image obtained by adding pixels to outside of the target image depending on a size of a predetermined filter matrix;
generate an integral image from the extended image, a value of each element of the integral image being a sum of pixel values of first pixels of the extended image, the first pixels being included in a direction toward an origin of the extended image from a pixel corresponding to the element of the integral image;
generate a partial-sum matrix for each pixel of the reduced image using the integral image, the partial-sum matrix having the same size as the filter matrix, a value of each element of the partial-sum matrix being a sum of pixel values of second pixels of the extended image, the second pixels being included in an area corresponding to the element of the partial-sum matrix;
perform a convolution operation on the partial-sum matrix using the filter matrix;
calculate a product of a result of the convolution operation and a predetermined reduction rate to obtain a pixel value of each pixel of the reduced image; and
output the reduced image.

2. The information processing apparatus according to claim 1, wherein the processor is configured to:
receive an original image;
generate the reduced image by inputting the original image as the target image;
repeat generation of a new reduced image by inputting the previously generated reduced image as the target image, to generate a plurality of reduced images having different reduction rates with respect to the original image; and
output the plurality of reduced images.

3. The information processing apparatus according to claim 1, wherein the processor is configured to:
generate a plurality of filter matrices corresponding to a plurality of reduced images including the reduced image, the plurality of reduced images having different reduction rates with respect to the target image;
generate the extended image depending on a maximum size among sizes of the plurality of filter matrices;
generate partial-sum matrices having a same size as the respective filter matrices;
perform the convolution operation on the partial-sum matrices using the respective filter matrices having the same size as the partial-sum matrices; and
obtain a pixel value of each pixel of the respective reduced images.

4. An image processing method for generating a reduced image from a target image, the image processing method comprising:
inputting the target image by a computer, the target image being a matrix of pixels;
generating an extended image obtained by adding pixels to outside of the target image depending on a size of a predetermined filter matrix;
generating an integral image from the extended image, a value of each element of the integral image being a sum of pixel values of first pixels of the extended image, the first pixels being included in a direction toward an origin of the extended image from a pixel corresponding to the element of the integral image;
generating a partial-sum matrix for each pixel of the reduced image using the integral image, the partial-sum matrix having the same size as the filter matrix, a value of each element of the partial-sum matrix being a sum of pixel values of second pixels of the extended image, the second pixels being included in an area corresponding to the element of the partial-sum matrix;
performing a convolution operation on the partial-sum matrix using the filter matrix;
calculating a product of a result of the convolution operation and a predetermined reduction rate to obtain a pixel value of each pixel of the reduced image; and
outputting the reduced image.

5. A non-transitory computer-readable recording medium having stored therein a program that causes a computer to execute a process for generating a reduced image from a target image, the process comprising:
inputting the target image, the target image being a matrix of pixels;
generating an extended image obtained by adding pixels to outside of the target image depending on a size of a predetermined filter matrix;
generating an integral image from the extended image, a value of each element of the integral image being a sum of pixel values of first pixels of the extended image, the first pixels being included in a direction toward an origin of the extended image from a pixel corresponding to the element of the integral image;
generating a partial-sum matrix for each pixel of the reduced image using the integral image, the partial-sum matrix having the same size as the filter matrix, a value of each element of the partial-sum matrix being a sum of pixel values of second pixels of the extended image, the second pixels being included in an area corresponding to the element of the partial-sum matrix;
performing a convolution operation on the partial-sum matrix using the filter matrix;
calculating a product of a result of the convolution operation and a predetermined reduction rate to obtain a pixel value of each pixel of the reduced image; and
outputting the reduced image.
